(19) United States
(12) Patent Application Publication
(10) Pub. No.: US 2025/0054266 A1
(43) Pub. Date: Feb. 13, 2025

(54) STORAGE MEDIUM STORING COMPUTER PROGRAM AND DATA PROCESSING APPARATUS

(71) Applicant: BROTHER KOGYO KABUSHIKI KAISHA, Nagoya (JP)

(72) Inventor: Masaki KONDO, Toyoake (JP)

(21) Appl. No.: 18/933,223

(22) Filed: Oct. 31, 2024

Related U.S. Application Data
(63) Continuation of application No. PCT/JP2023/017387, filed on May 9, 2023.

(30) Foreign Application Priority Data
May 17, 2022 (JP) 2022-080604

(51) Int. Cl. G06V 10/25; G06V 10/774; G06V 20/60

(52) U.S. Cl. CPC G06V 10/25; G06V 10/774; G06V 20/60

(57) ABSTRACT

A set of program instructions, when executed by a computer, causes the computer to perform: acquiring captured image data of a captured image including a first object; acquiring first image data from the captured image data, the first image data representing the first object with a first number of pixels; detecting a first type region indicating the first object by using the first image data; acquiring second image data from the captured image data, the second image data indicating a partial image; detecting a second type region by using the second image data, the second type region indicating at least part of the first object, the second image data representing the first object with a second number of pixels, the second number of pixels being greater than the first number of pixels; and inspecting the first object by using a detection result of the second type region.

### REFERENCE TO RELATED APPLICATIONS

This is a Continuation Application of International Application No. PCT/JP2023/017387 filed on May 9, 2023, which claims priority from Japanese Patent Application No. 2022-080604 filed on May 17, 2022. The entire content of each of the prior applications is incorporated herein by reference.

### BACKGROUND ART

A technique for detecting an object from an image is used for various purposes such as visual inspection of a product and recognition of an object by a robot.

### SUMMARY

As a technique for detecting an object, for example, the following paper proposes a machine learning model called YOLOv4. The YOLOv4 predicts a frame (referred to as a bounding box) that encloses an object and a type (also referred to as a class) of the object.

It is not easy to detect an object, and a region inappropriate as a region representing an object may be determined. For example, an object different from the target object may be erroneously detected. Thus, there is room for improvement in detecting a region representing an object.

In view of the foregoing, this specification discloses an example of a technique for detecting a region representing at least part of an object.

According to one aspect, this specification discloses a non-transitory computer-readable storage medium storing a set of program instructions for a computer. The set of program instructions, when executed by the computer, causes the computer to perform acquiring captured image data of a captured image including a first object. Thus, the captured image data of the captured image including the first object is acquired. The set of program instructions, when executed by the computer, causes the computer to perform acquiring first image data from the captured image data. The first image data represents the first object with a first number of pixels. Thus, the first image data is acquired from the captured image data. The set of program instructions, when executed by the computer, causes the computer to perform detecting a first type region indicating the first object by using the first image data. Thus, the first type region indicating the first object is detected. The set of program instructions, when executed by the computer, causes the computer to perform acquiring second image data from the captured image data. The second image data indicates a partial image. The partial image includes the first type region of the captured image. The partial image does not include at least part of a remaining region other than the first type region of the captured image. Thus, the second image data is acquired from the captured image data. The set of program instructions, when executed by the computer, causes the computer to perform detecting a second type region by using the second image data. The second type region indicates at least part of the first object. The second image data represents the first object with a second number of pixels. The second number of pixels is greater than the first number of pixels. Thus, the second type region is detected by using the second image data. The set of program instructions, when executed by the computer, causes the computer to perform inspecting the first object by using a detection result of the second type region. Thus, the first object is inspected by using the detection result of the second type region.

According to this configuration, the second type region used for inspection is detected using the second image data representing the first object with the second number of pixels greater than the first number of pixels used for detection of the first type region. Thus, an appropriate detection result of the second type region representing at least part of the first object is used for inspection of the first object.

The technique disclosed in this specification may be realized in various modes, and may be realized in the form of, for example, a data processing method and a data processing apparatus, a computer program for realizing the functions of the method or apparatus, a storage medium (for example, a non-transitory storage medium) in which the computer program is stored, and so on.

### BRIEF DESCRIPTION OF DRAWINGS

FIG. 1 is an explanatory diagram showing a data processing apparatus.

FIGS. 2A, 2B and 2C are schematic diagrams showing examples of labels.

FIGS. 3A and 3B are explanatory diagrams showing examples of regions detected by object detection models M1 and M2.

FIG. 4 is a flowchart showing an example of a training process.

FIGS. 5A, 5B, 5C and 5D are schematic diagrams showing examples of images used in a training process of a first-type object detection model M1.

FIGS. 6A, 6B and 6C are schematic diagrams showing examples of composite images for the first-type object detection model M1.

FIGS. 6D, 6E and 6F are schematic diagrams showing examples of composite images for a second-type object detection model M2.

FIG. 7 is a flowchart showing an example of an inspection process.

FIGS. 8A, 8B, 8C, 8D and 8E are schematic diagrams showing examples of images used in the inspection process.

FIG. 9 is a flowchart showing a training process.

FIG. 10A is a schematic diagram showing an example of element regions.

FIG. 10B is a schematic diagram showing an example of relative position information.

FIGS. 11A, 11B, 11C and 11D are schematic diagrams showing an example of image processing.

FIGS. 12A, 12B and 12C are schematic diagrams showing examples of composite images.

FIG. 13 is a flowchart showing an inspection process.

FIGS. 14A and 14B are schematic diagrams showing detection of elements.

FIGS. 15A, 15B and 15C are schematic diagrams showing examples of composite images used in a training process.

FIG. 16A is a part of a flowchart showing a training process.

FIG. 16B is a schematic diagram of model data.

### DESCRIPTION

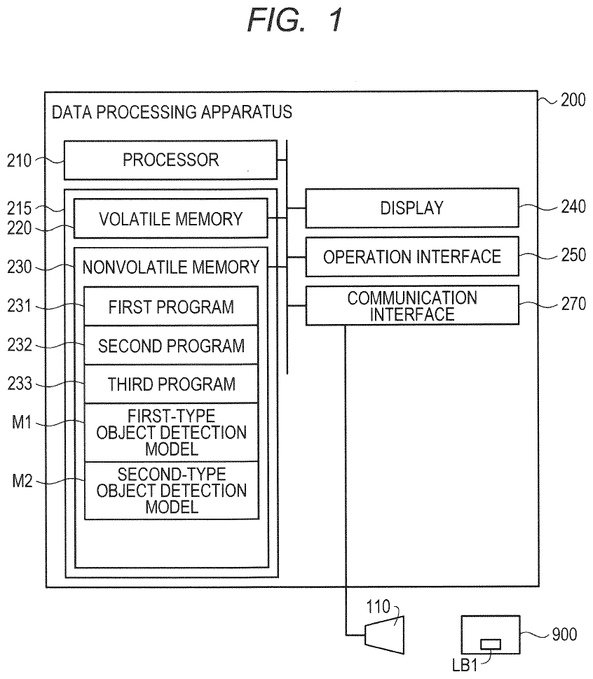

FIG. 1 is an explanatory diagram showing a data processing apparatus according to an embodiment. In the present embodiment, a data processing apparatus 200 is, for example, a personal computer. The data processing apparatus 200 is an example of a data processing apparatus that performs data processing for inspecting visual of an object (for example, a label) provided on a product (for example, a multifunction peripheral). In the present embodiment, a first label LB1 is affixed to a multifunction peripheral (MFP) 900. In the present embodiment, the visual of the first label LB1 is inspected.

The data processing apparatus 200 includes a processor 210, a memory 215, a display 240, an operation interface 250, and a communication interface 270. These elements are connected to each other via a bus. The memory 215 includes a volatile memory 220 and a nonvolatile memory 230.

The processor (controller) 210 is a device configured to perform data processing, and is a CPU, for example. The volatile memory 220 is a DRAM, for example, and the nonvolatile memory 230 is a flash memory, for example. The nonvolatile memory 230 stores programs 231, 232, and 233, and object detection models M1 and M2. In the present embodiment, the models M1 and M2 are program modules. The models M1 and M2 are so-called machine learning models. The programs 231, 232, and 233 and the models M1 and M2 will be described in detail later.

The display 240 is a device configured to display an image, such as a liquid crystal display or an organic EL display. The operation interface 250 is a device configured to receive an operation by a user, such as a button, a lever, or a touch panel arranged to overlap the display 240. The user inputs various instructions to the data processing apparatus 200 by operating the operation interface 250. The communication interface 270 is an interface for communicating with other apparatuses. The communication interface 270 includes, for example, one or more of a USB (universal serial bus) interface, a wired LAN (local area network) interface, and a wireless interface of IEEE802.11, for example. The communication interface 270 is connected to a digital camera 110. The digital camera 110 captures an image of a portion of the MFP 900 including the first label LB1.

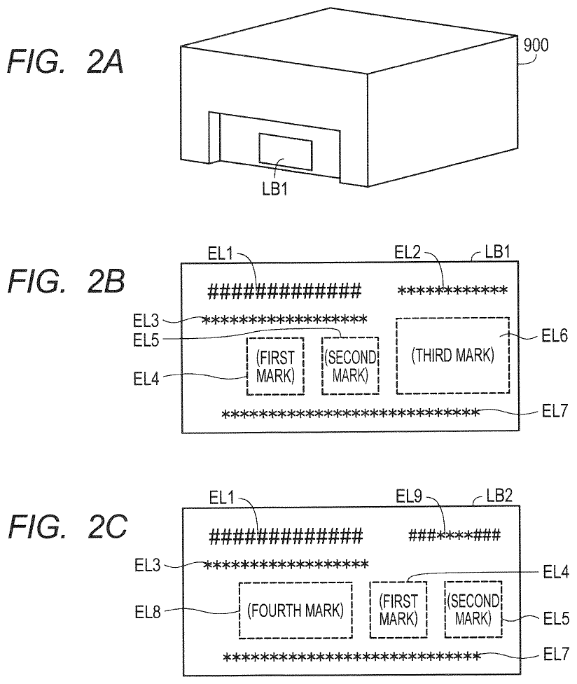

FIGS. 2A to 2C are schematic diagrams of an example of a label. FIG. 2A is a perspective view of the MFP 900. The first label LB1 is affixed to the outer surface of the body of the MFP 900.

FIG. 2B shows an example of the first label LB1. In this embodiment, the first label LB1 has a rectangular shape. The first label LB1 includes seven elements EL1, EL2, EL3, EL4, EL5, EL6, and EL7. The elements EL1, EL2, EL3, and EL7 are character strings (for example, brand name, model name, rated input, manufacturer name, country of manufacture, and so on) indicating information related to the MFP 900. The elements EL4, EL5, and EL6 are marks (for example, logo mark, CE mark, WEEE mark, GS mark, FCC mark, and so on) associated with the MFP 900.

FIG. 2C shows an example of a second label LB2. The second label LB2 is a label to be affixed to another product that is different from the MFP 900. There are two differences between the second label LB2 and the first label LB1. The first difference is that the second element EL2 and the sixth element EL6 are omitted, and, instead, an eighth element EL8 indicating a mark and a ninth element EL9 indicating a character string are added. The second difference is that the position of the elements EL4 and ELS is different between the first label LB1 and the second label LB2. The first label LB1 and the second label LB2 both contain the elements EL1, EL3 to EL5, and EL7. The second label LB2 is similar to the first label LB1. Thus, the second label LB2 may be mistakenly affixed to the MFP 900 instead of the first label LB1.

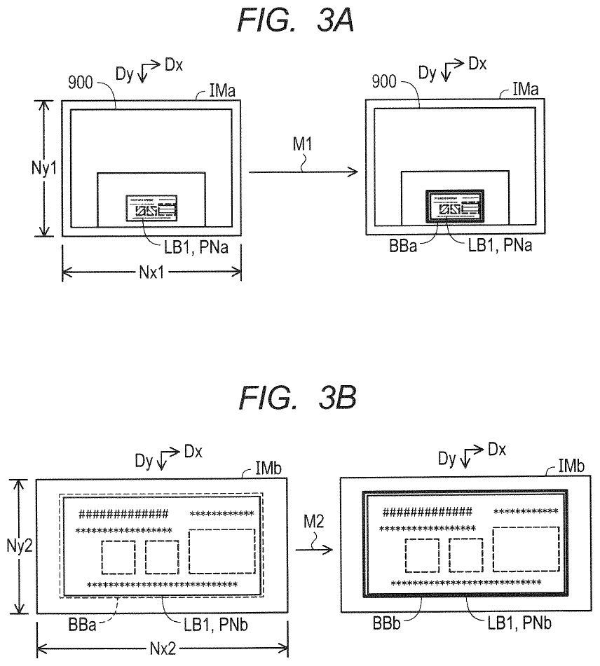

FIGS. 3A and 3B are explanatory diagrams showing examples of regions detected by object detection models M1 and M2 (FIG. 1). The first-type object detection model M1 and the second-type object detection model M2 may be detection models that detect various objects. In this embodiment, the first-type object detection model M1 and the second-type object detection model M2 are machine learning models both called YOLOv4. A YOLOv4 model predicts a bounding box, which is a rectangular frame including at least part of an object, a confidence that the bounding box includes the object (also referred to as object score), and the probability (also referred to as class probability) of each type of object (also referred to as class) when the bounding box contains the object. Various methods may be used to determine the final predicted result of object detection. For example, a confidence score for each class and bounding box is calculated from the confidence (object score) and class probability. The confidence score may be expressed, for example, as the product of the object score and the class probability. Combinations of bounding boxes and classes with confidence scores above a threshold is used as the final prediction result. The threshold may be determined experimentally in advance to acquire the appropriate detection results, for example.

FIG. 3A shows a first captured image IMa, which is an example of an image input to the first-type object detection model M1. The first captured image IMa is a rectangular image with two sides parallel to a first direction Dx (here, the horizontal direction) and two sides parallel to a second direction Dy (here, the vertical direction), which is perpendicular to the first direction Dx. The first captured image IMa is represented by color values of a plurality of pixels arranged in a matrix along the first direction Dx and the second direction Dy. In this embodiment, the color values are represented by three component values, R (red), G (green), and B (blue). Each component value is represented by 256 gradations from 0 to 255, for example. A first horizontal size Nx1 indicates the number of pixels in the first direction Dx, and a first vertical size Ny1 indicates the number of pixels in the second direction Dy.

The first captured image IMa represents the entire MFP 900. The first captured image IMa contains an image of the first label LB1. The first-type object detection model M1 is trained to detect a bounding box BBa representing the first label LB1 from the first captured image IMa. A first number of pixels PNa in the drawing is the total number of the plurality of pixels representing the first label LB1. The pixel density of the plurality of pixels representing the first label LB1 is higher as the first number of pixels PNa increases.

FIG. 3B shows a second captured image IMb, which is an example of an image input to the second-type object detection model M2. Similar to the first captured image IMa, the second captured image IMb is a rectangular image with two sides parallel to the first direction Dx and two sides parallel to the second direction Dy. The second captured image IMb is represented by color values (here, the three component values R, G, and B) of a plurality of pixels arranged in a matrix along the first direction Dx and the second direction Dy. A second horizontal size Nx2 indicates the number of pixels in the first direction Dx, and a second vertical size Ny2 indicates the number of pixels in the second direction Dy.

The second captured image IMb represents a portion of the first captured image IMa, the portion including a portion surrounded by the bounding box BBa. The second captured image IMb contains the image of the first label LB1. The second-type object detection model M2 is trained to detect a bounding box BBb that represents the first label LB1 from the second captured image IMb. A second number of pixels PNb in the drawing is the total number of the plurality of pixels representing the first label LB1. The pixel density of the plurality of pixels representing the first label LB1 is higher as the second number of pixels PNb increases.

The number of pixels Nx1, Ny1, Nx2, Ny2 (that is, the sizes of the images input to the object detection models M1 and M2) are predetermined. In this embodiment, the number of pixels Nx1, Ny1, Nx2, and Ny2 are determined such that the second number of pixels PNb of the second captured image IMb is greater than the first number of pixels PNa of the first captured image IMa. In other words, the sizes Nx1, Ny1, Nx2, and Ny2 are determined such that the number of pixels representing the first label LB1 in the image input to the second-type object detection model M2 is greater than the number of pixels representing the first label LB1 input to the first-type object detection model M1. For example, the second horizontal size Nx2 may be greater than the first horizontal size Nx1. Additionally, the second vertical size Ny2 may be greater than the first vertical size Ny1.

In this embodiment, the first label LB1 in the image input to the second-type object detection model M2 (for example, the second captured image IMb) is larger than the first label LB1 in the image input to the first-type object detection model M1 (for example, the first captured image IMa). In other words, the ratio of the portion representing the first label LB1 to the image input into the second-type object detection model M2 is greater than the ratio of the portion representing the first label LB1 to the image input into the first-type object detection model M1. Accordingly, the second horizontal size Nx2 may be the same as or less than the first horizontal size Nx1. Further, the second vertical size Ny2 may be the same as or less than the first vertical size Ny1.

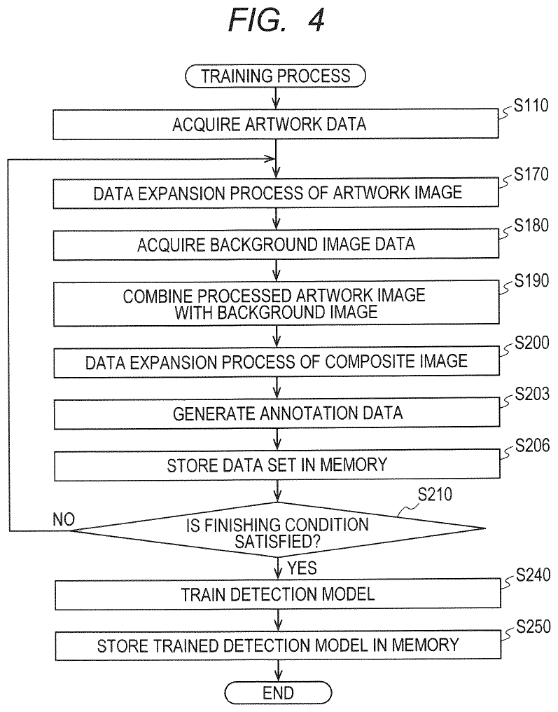

FIG. 4 is a flowchart showing an example of a training process. In this embodiment, the first-type object detection model M1 and the second-type object detection model M2 are trained according to the processing in FIG. 4. The first program 231 is a program for performing a training process for the first-type object detection model M1, and the second program 232 is a program for performing training process for the second-type object detection model M2. An operator inputs a start instruction for the training process to the data processing apparatus 200 by operating the operation interface 250 (FIG. 1). The start instruction that is input includes information indicating the model of the processing target (the first-type object detection model M1 or the second-type object detection model M2). The processor 210 starts the training process of the model subjected to the processing according to the start instruction. First, the training process for the first-type object detection model M1 will be described. The processor 210 trains the first-type object detection model M1 by performing the first program 231.

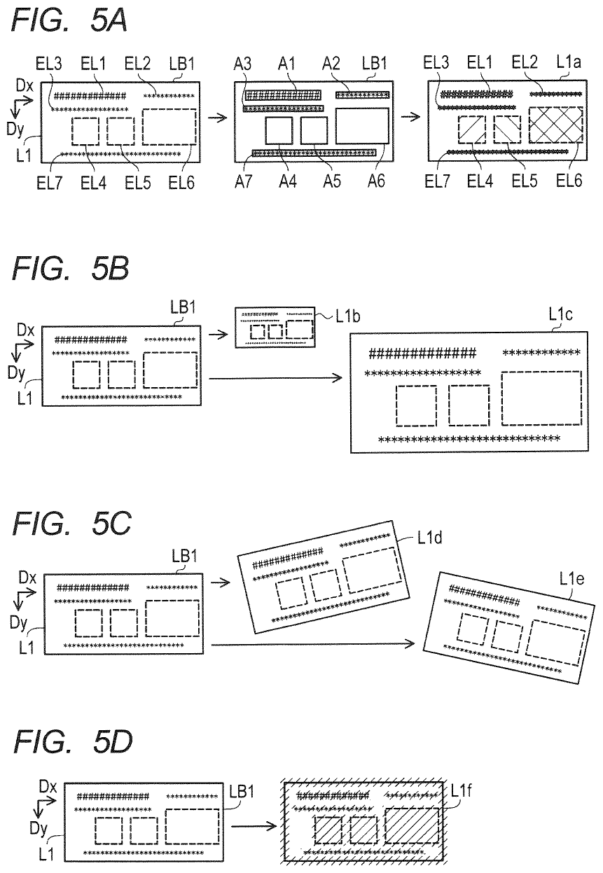

S110 to S210 is processing of generating training image data. In this embodiment, the processor 210 generates a plurality of training image data using artwork data of an artwork image. In S110, the processor 210 acquires the artwork data. FIGS. 5A to 5D are schematic diagrams of examples of images used in the training process for the first-type object detection model M1. In each diagram, an image L1 is an example of an artwork image (the image L1 will be referred to as “artwork image L1”). The artwork image L1 is an image of the design of the first label LB1. In this embodiment, the first label LB1 is produced by printing the image of the first label LB1 onto a sheet. The artwork image is the image of the first label LB1 to be printed. The shape of the artwork image L1 is a rectangle having two sides parallel to the first direction Dx and two sides parallel to the second direction Dy.

The data format of the artwork data may be in various formats, such as bitmap or vector. In this embodiment, the artwork data is in bitmap format. The artwork data is stored in the nonvolatile memory 230 in advance (not shown). The processor 210 acquires the plate data from the nonvolatile memory 230.

In S170 (FIG. 4), the processor 210 performs a data expansion process on the artwork image. The data expansion process is a process of increasing the number of image data by performing image processing. Various types of image processing may be performed. FIGS. 5A to 5D each show examples of the image processing.

The image processing shown in FIG. 5A is a color change process. First, as shown in the center portion of FIG. 5A, the processor 210 determines partial regions A1 to A7 that represent the elements EL1 to EL7 in the artwork image L1, respectively. In this embodiment, the processor 210 determines the partial regions A1 to A7 by analyzing the artwork image L1. Different types of processing may be used to determine the partial regions A1 to A7. For example, the processor 210 selects pixels having colors within a particular background color range as background pixels and selects other pixels as element pixels. Then, the processor 210 selects a region in which a plurality of the element pixels are continuous as the partial region. In the example in FIG. 5A, the partial regions A1 to A7 that are separated from each other are selected. Alternatively, the operator may input information designating each of the partial regions A1 to A7 via the operation interface 250. The processor 210 may use the inputted information to determine the partial regions A1 to A7.

Next, the processor 210 generates data for a processed artwork image L1a by changing the color values of each of the partial regions A1 to A7. The processor 210 uses random numbers to change the color values. For example, the processor 210 uses a random number to determine the amount of change for red R, the amount of change for green G, and the amount of change for blue B, respectively, for each partial region A1 to A7. The amount of change may be, for example, a value acquired by multiplying a random number between −1 and 1 by 10. Then, the processor 210 changes the color values of each of the partial regions A1 to A7 by adding the corresponding color change amounts to the component values of red R, green G, and blue B of each pixel in the partial regions A1 to A7. The processed artwork image L1a is an image of the first label containing elements EL1 to EL7 represented in colors different from the original colors.

The image processing shown in FIG. 5B is an image resizing process. As the image resizing process, either a reduction process or an enlargement process is performed. The reduction process reduces the number of pixels (that is, pixel density) of the image. For example, the processor 210 generates data of a processed artwork image L1b, which represents a reduced first label, by performing the reduction process on the data of the artwork image L1. The enlargement process increases the number of pixels (that is, pixel density) of the image. For example, the processor 210 generates data of a processed artwork image L1c, which represents an enlarged first label, by performing the enlargement process on the data of the artwork image L1. The processor 210 uses a random number to determine the ratio of the size before processing to the size after processing (for example, the ratio of pixel density). Various methods may be used to determine the color value of each pixel in the image resizing process (for example, nearest neighbor, bilinear, bicubic, and so on). The processor 210 may also change the aspect ratio (horizontal to vertical ratio) of the image.

The image processing shown in FIG. 5C is a rotation process of an image. For example, the processor 210 generates data of a processed artwork image L1d, which represents a rotated first label, by rotating the artwork image L1 counterclockwise. The processor 210 also generates data of a processed artwork image L1e, which represents a rotated first label, by rotating the artwork image L1 clockwise. The processor 210 uses a random number to determine the rotation angle. Various methods may be used to determine the color value of each pixel in the rotation process (for example, nearest neighbor, bilinear, bicubic, and so on).

The image processing shown in FIG. 5D is a blurring process. For example, the processor 210 performs the blurring process on the artwork image L1 to generate data of a processed artwork image L1f, which represents a blurred first label. The blurring process is also referred to as smoothing. A variety of types of processing may be used for the blurring process. In this embodiment, the processor 210 performs a filter process using a smoothing filter (for example, a median filter).

In S170 (FIG. 4), the processor 210 may perform various other types of image processing (for example, noise addition), not limited to the image processing described with reference to FIGS. 5A to 5D. The processor 210 may also perform a plurality of types of image processing to generate data of one processed artwork image. For example, the processor 210 may generate data of the processed artwork image by performing the rotation process and the enlargement process. In this embodiment, the processor 210 uses a random number to determine the type of the image processing of S170.

In S180, the processor 210 acquires background image data. The background image is combined with the processed artwork image (that is, the image of the first label LB1) (described in detail later). A variety of images may be used for the background image. For example, a variety of photographic images may be used for the background image. The background image may be a photographic image of the MFP 900. The background image may be a photographic image of another subject different from the MFP 900. Alternatively, instead of a photographic image, various types of graphics may be used for the background image. For example, a drawn image that is drawn by a computer may be used as the graphic. The drawn image may be, for example, a uniformly patterned image or a plain image. The drawn image may be a random pattern expressed in random colors.

In this embodiment, the processor 210 uses random numbers to acquire the background image data. Specifically, a plurality of background image data (not shown) representing background images that differ from each other are stored in advance in the nonvolatile memory 230. The processor 210 uses random numbers to determine whether to generate new background image data. In response to determining to generate new data, the processor 210 determines the pattern of the background image using random numbers and determines the color of the pattern using random numbers. In response to determining not to generate new data, the processor 210 acquires the background image data from the nonvolatile memory 230 using random numbers.

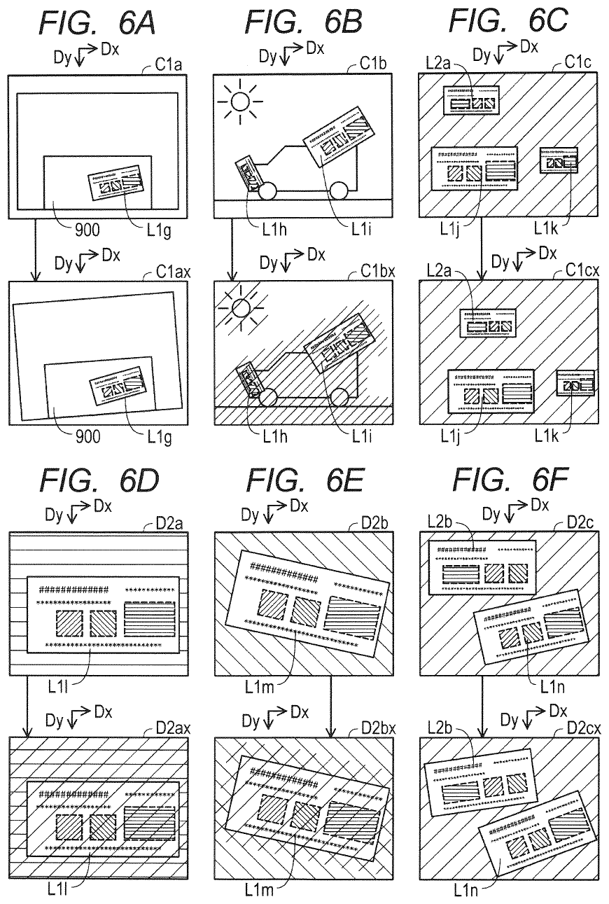

In S190, the processor 210 generates a composite image by combining the background image and the processed artwork image. The processor 210 determines the position of the processed artwork image on the background image by using a random number. FIGS. 6A to 6C are schematic diagrams showing examples of composite images for the first-type object detection model M1. A composite image C1a in FIG. 6A is acquired by superimposing one processed artwork image L1g of the first label LB1 on a photographic image of the MFP 900.

A composite image C1b in FIG. 6B is acquired by superimposing two processed artwork images L1h and L1i of the first label LB1 on a drawn image. Thus, one composite image may include two or more images of the first label LB1. In S170, the processor 210 may generate data of a plurality of processed artwork images by performing different types of image processing. The processor 210 may use random numbers to determine the total number (for example, an integer greater than or equal to 1) of processed artwork images of the first label LB1 to be combined.

A composite image C1c in FIG. 6C is acquired by superimposing two processed artwork images L1j and L1k of the first label LB1 and one processed artwork image L2a of the second label LB2 on a plain image. Thus, the composite image may include an image of a different label from the first label LB1 (for example, the second label LB2). For example, in S170, the processor 210 further performs a data expansion process of an artwork image of a non-target label (for example, the second label LB2), which is a label different from the first label LB1 of the processing target. Then, in S190, the processor 210 combines the processed artwork image of the non-target label with the background image in addition to the processed artwork image of the first label LB1. The processor 210 may use random numbers to determine the total number (for example, an integer greater than or equal to 0) of processed artwork images of the non-target label to be combined.

When one composite image contains a plurality of label images, the processor 210 combines the plurality of label images such that the images do not overlap each other.

In S200 (FIG. 4), the processor 210 performs the data expansion process on the composite image. In S200, the processor 210 performs various image processing, similar to in S170. For example, a processed composite image C1ax in FIG. 6A is generated by a rotation process performed on the composite image C1a. A processed composite image C1bx in FIG. 6B is generated by performing the blurring process on the composite image C1b. A processed composite image C1cx in FIG. 6C is generated by translating the composite image C1c. The processor 210 uses random numbers to determine the type of the image processing of S200.

In S203 (FIG. 4), the processor 210 generates annotation data to be associated with the data of the processed composite image. The annotation data indicates the appropriate bounding box (for example, a rectangle with two sides parallel to the first direction Dx and two sides parallel to the second direction Dy, and the smallest rectangle enclosing the image of the detection target (for example, the first label LB1)) and the appropriate class (for example, label identification number). In this embodiment, the processor 210 generates the annotation data based on the content of the processing in S170, S190, and S200. In this embodiment, the first-type object detection model M1 is trained to detect the first label LB1. Accordingly, information indicating other labels may be omitted from the annotation data. For example, information indicating the bounding box and the class representing the processed artwork image L2a in FIG. 6C may be omitted.

In S206, the processor 210 stores a set of training image data, which is the data of the processed composite image, and the annotation data in the nonvolatile memory 230. Hereafter, the training image for the first-type object detection model M1 is also referred to as a “first type training image”.

In S210 (FIG. 4), the processor 210 determines whether a finishing condition is satisfied. The finishing condition may be a variety of conditions indicating that a plurality of training image data for appropriate training is generated. For example, the finishing condition may be that the total number of training image data is greater than or equal to a particular threshold. In a case where the finishing condition is not satisfied (S210: No), the processor 210 moves to S170 to generate new training image data.

In a case where the finishing condition is satisfied (S210: Yes), in S240, the processor 210 trains the first-type object detection model M1 to detect the first label LB1, by using the training image data. The method of training the first-type object detection model M1 may be any method suitable for the first-type object detection model M1.

For example, the processor 210 generates output data by performing operations on the first-type object detection model M1 using the training image data. The processor 210 then adjusts a plurality of parameters of the first-type object detection model M1 such that the output data approaches the correct answer indicated by the annotation data corresponding to the training image input to the object detection model M1. The plurality of parameters of the first-type object detection model M1 include a plurality of weights and a plurality of biases of a plurality of filters in convolution layers.

Various methods of adjusting the parameters may be used. In this embodiment, the plurality of parameters of the first-type object detection model M1 are adjusted such that a loss value calculated using a loss function is smaller. The loss function may be any type of function that calculates an evaluation value of the difference between the output data and data of the correct answer. As an algorithm for adjusting the plurality of parameters, an algorithm using, for example, the error back propagation method and the gradient descent method may be employed. Here, the Adam optimizer may be used.

In the present embodiment, the first-type object detection model M1 is a YOLOv4 model. The first-type object detection model M1 may be trained by a training method described in the following paper of YOLOv4, which is Alexey Bochkovskiy, Chien-Yao Wang, Hong-Yuan Mark Liao, “YOLOv4: Optimal Speed and Accuracy of Object Detection”, arXiv: 2004.10934 (2020), https://arxiv.org/abs/2004.10934.

In S250, the processor 210 stores data indicating the trained first-type object detection model M1 in the memory 215 (here, the nonvolatile memory 230). Then, the processor 210 ends the processing of FIG. 4. The trained first-type object detection model M1 is used in an inspection process described later.

Next, the training process of the second-type object detection model M2 is described. The processor 210 trains the second-type object detection model M2 by performing the second program 232. The training process of the second-type object detection model M2 is different from the training process of the first-type object detection model M1 in that the training image represents the first label LB1 with a greater number of pixels in the training process of the second-type object detection model M2. The procedure of the training process is the same as the procedure in FIG. 4.

FIGS. 6D to 6F are schematic diagrams showing examples of composite images for the second-type object detection model M2. A composite image D2a in FIG. 6D is acquired by superimposing one processed artwork image L1l of the first label LB1 on a background image (S190). A processed composite image D2ax is generated by performing a noise addition process on the composite image D2a (S200). A composite image D2b in FIG. 6E is acquired by superimposing one processed artwork image LIm of the first label LB1 on a background image (S190). A processed composite image D2bx is generated by performing a blurring process on the composite image D2b (S200). A composite image D2c in FIG. 6F is acquired by superimposing one processed artwork image L1n of the first label LB1 and one processed artwork image L2b of the second label LB2 on a background image. A processed composite image D2cx is generated by performing a rotation process on the composite image D2c (S200). Thus, the composite image may include an image with a different label from the first label LB1 (for example, the second label LB2).

In S110 to S210 (FIG. 4), the processor 210 generates data of various training images, such as the processed composite images D2ax, D2bx, and D2cx. Hereafter, the training images for the second-type object detection model M2 are also referred to as “second type training images”. In this embodiment, the number of pixels representing one first label LB1 in the second type training images is greater than the number of pixels representing one first label LB1 in the first type training images (for example, processed composite images C1ax to C1cx (FIGS. 6A to 6C)). In other words, the second type training images represent the first label LB1 with a higher pixel density than the first type training images. In this embodiment, the ratio of the portion of the second type training images that show the one first label LB1 is greater than the ratio of the portion of the first type training images (for example, the processed composite images C1ax to C1cx (FIGS. 6A to 6C)) that show the one first label LB1.

In S240 (FIG. 4), the processor 210 trains the second-type object detection model M2 to detect the first label LB1, by using data of a plurality of the second type training images. The method of training the second-type object detection model M2 may be any method suitable for the second-type object detection model M2. For example, the second-type object detection model M2 may be trained by using the same method as the training method of the first-type object detection model M1.

In S250, the processor 210 stores data indicating the trained second-type object detection model M2 in the memory 215 (here, the nonvolatile memory 230). The processor 210 then ends the processing of FIG. 4. The trained second-type object detection model M2 is used in the inspection process described later.

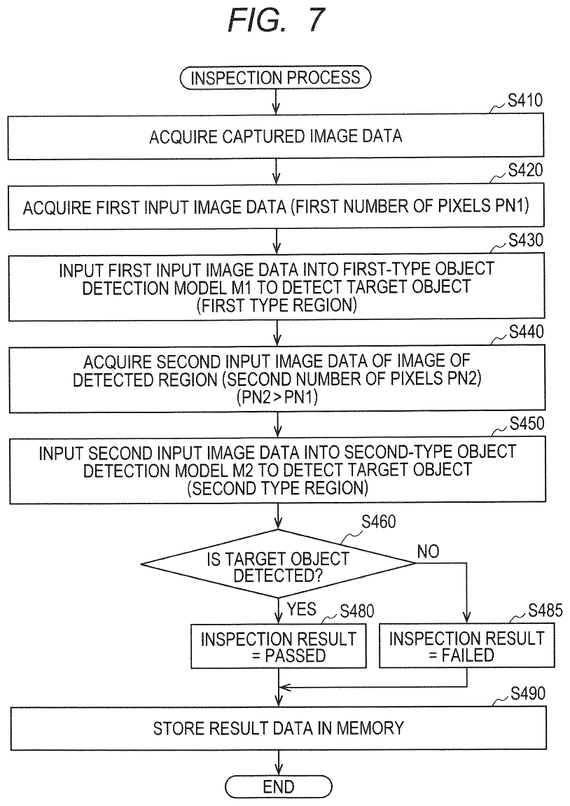

FIG. 7 is a flowchart showing an example of the inspection process. The data processing apparatus 200 (FIG. 1) performs the inspection process to inspect the visual of the first label LB1 of the MFP 900 (FIG. 2A). The third program 233 is a program for the inspection process.

In this embodiment, the MFP 900 is placed in a particular position for inspection. The position of the MFP 900 is a suitable position for capturing the first label LB1 by the digital camera 110. In this embodiment, the MFP 900 is placed by a machine such as a conveyor belt. After the MFP 900 is placed, a start instruction to start the inspection process is input to the data processing apparatus 200. In this embodiment, an operator inputs the start instruction for the inspection process by operating the operation interface 250. The processor 210 starts the inspection process in response to the start instruction. The MFP 900 may be placed by the operator. Instead of placing the MFP 900, the position of the digital camera 110 may be adjusted to a position suitable for the MFP 900. The start instruction may be supplied to the data processing apparatus 200 by another apparatus different from the data processing apparatus 200, via the communication interface 270.

In S410, the processor 210 supplies an image capturing instruction to the digital camera 110. The digital camera 110 captures an image of the MFP 900 in response to the instruction and generates data representing the captured image. The processor 210 acquires the data of the captured image from the digital camera 110.

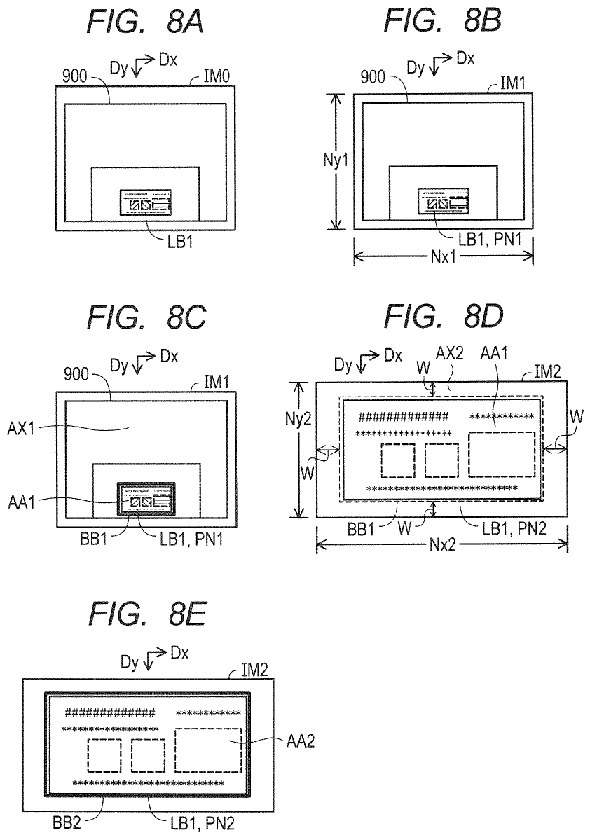

FIGS. 8A to 8E are schematic diagrams showing examples of images used in the inspection process. An image IM0 in FIG. 8A is an example of a captured image (the image IM0 is referred to as “captured image IM0”). The captured image IM0 contains the image of the first label LB1.

In S420 (FIG. 7), the processor 210 acquires first input image data to be input to the first-type object detection model M1, by using the data of the captured image. An image IM1 in FIG. 8B is an example of the first input image (the image IM1 will be referred to as “first input image IM1”). The processor 210 generates the first input image data by performing a cropping process and a resolution conversion process on the captured image data. Thus, the first input image represents a captured image. The portion of the captured image that may represent the first label LB1 is predetermined. The processor 210 generates the first input image data such that the first input image includes the portion that may represent the first label LB1. Thereby, the first input image includes the entire image of the first label LB1. A first number of pixels PN1 in FIG. 8B indicates the total number of pixels in the first input image IM1 that represents the first label LB1.

In S430 (FIG. 7), the processor 210 inputs the first input image data into the first-type object detection model M1 to detect a first type region representing a target object (in this case, the first label LB1). In this embodiment, the bounding box representing the first label LB1 is detected by the first-type object detection model M1. Hereafter, the bounding box detected by the first-type object detection model M1 is referred to as “first type bounding box”. The first type region is a region surrounded by the first type bounding box. A box BB1 in FIG. 8C is an example of the first type bounding box detected from the first input image IM1. The first type bounding box BB1 surrounds the first label LB1. A region AA1 represents the first type region. A first remaining region AX1 is the remaining region of the first input image IM1 excluding the first type region AA1.

In S440 (FIG. 7), the processor 210 acquires second input image data to be input to the second-type object detection model M2, by using the data of the captured image and the first type bounding box. An image IM2 in FIG. 8D is an example of the second input image (the image IM2 will be referred to as “second input image IM2”). The processor 210 generates the second input image data by performing a cropping process and a resolution conversion process on the captured image data. Thus, the second input image IM2 represents the captured image. The processor 210 generates the second input image data such that at least part of the first remaining region AX1 (FIG. 8C) is not included in the second input image IM2. For example, a portion of the first remaining region AX1 that is far from the first type region AA1 is excluded. The processor 210 generates the second input image data such that the entire first type region AA1 and a peripheral portion AX2 (FIG. 8D) surrounding the first type region AA1 are included in the second input image IM2. A portion of the image of the first label LB1 may protrude to outside of the first type bounding box. In this case also, the second input image IM2 includes the entire image of the first label LB1. The second number of pixels PN2 in the drawings represents the total number of pixels representing the first label LB1 in the second input image IM2. In this embodiment, the processor 210 generates the second input image data such that PN2 is greater than PN1 (PN2>PN1).

Any method may be used to determine the peripheral portion AX2 (that is, the remaining portion of the second input image IM2 excluding the first type region AA1). For example, the processor 210 may determine the peripheral portion AX2 such that a width W of the peripheral portion AX2 is greater than or equal to a particular width threshold over the entire circumference of the first type region AA1. The peripheral portion AX2 may be omitted from the second input image IM2. In other words, the second input image IM2 may be an image of a rectangular region bounded by the first type region AA1.

In this embodiment, the pixel density of the captured image IM0 (FIG. 8A) generated by the digital camera 110 is determined in advance to represent the first label LB1 with a higher pixel density than the input images IM1 and IM2 (FIG. 8B and FIG. 8D). Accordingly, the second input image IM2 represents the first label LB1 without blurring. In S420 and S440, resolution conversion is performed to reduce pixel density. The pixel density of the captured image IM0 may be any pixel density with which the second input image IM2 represents the first label LB1 more clearly than the first input image IM1. For example, the pixel density of the captured image IMO may have various values such that the first label LB1 is represented with a pixel density higher than the pixel density of the first label LB1 in the first input image IM1. The pixel density (the number of pixels) of the first label LB1 in the captured image IM0 may be less than or equal to the pixel density (the number of pixels) of the first label LB1 in the second input image IM2.

In S450 (FIG. 7), the processor 210 inputs the second input image data into the second-type object detection model M2 to detect a second type region representing a target object (in this case, the first label LB1). In this embodiment, a bounding box representing the first label LB1 is detected by the second-type object detection model M2. Hereafter, the bounding box detected by the second-type object detection model M2 is referred to as “second type bounding box”. The second type region is a region surrounded by the second type bounding box. A box BB2 in FIG. 8E is an example of the second type bounding box detected from the second input image IM2. The second type bounding box BB2 surrounds the first label LB1. A region AA2 represents the second type region.

In S460, the processor 210 determines whether the target object (here, the first label LB1) is detected in S450. In this embodiment, in a case where the second type bounding box for the first label LB1 (that is, the second type region AA2) is detected, the decision result is “Yes”. In this case, in S480, the processor 210 sets an inspection result to “Passed”, and the processor 210 advances the processing to S490.

In a case where the second type bounding box for the first label LB1 is not detected (S460: No), in S485, the processor 210 sets the inspection result to “Failure”, and the processor 210 advances the processing to S490.

In S490, the processor 210 stores data indicating the inspection result in the memory 215 (for example, the nonvolatile memory 230). The processor 210 ends the processing of FIG. 7.

As described above, in this embodiment, the processor 210 of the data processing apparatus 200 performs the following processing. In S430 of FIG. 7, the processor 210 detects the first type region AA1 representing the first label LB1 from the first input image IM1 (FIG. 8C) using the first input image data. The first label LB1 is an example of a first object that is an object of the processing target. The first input image IM1 is an example of a captured image of the first label LB1. The first input image data is an example of the first image data of the captured image of the first label LB1. As shown in FIG. 8C, the first input image data represents the first label LB1 with the first number of pixels PN1.

In S450 of FIG. 7, the processor 210 uses the second input image data to detect the second type region AA2 representing the first label LB1 from the second input image IM2 (FIG. 8E). The second input image IM2 is a partial image including the first type region AA1, in the first input image IM1 (FIG. 8C). The second input image IM2 is an image that does not include at least part of the first remaining region AX1 (FIG. 8C). The first remaining region AX1 is the remaining region of the first input image IM1 excluding the first type region AA1. The data of the second input image IM2 represents the first label LB1 with the second number of pixels PN2, which is greater than the first number of pixels PN1.

In S460 to S485, the processor 210 inspects the first label LB1 by using the detection result of the second type region AA2. In this embodiment, in a case where the second type region AA2 is detected (S460: Yes), the inspection result is “Passed” (S480). In a case where the second type region AA2 is not detected (S460: No), the inspection result is “Failed” (S485).

A label different from the first label LB1 (for example, the second label LB2) may be mistakenly affixed to the MFP 900 (FIG. 2A). A defective label may be affixed to the MFP 900. The second input image data used in S450 (FIG. 7) represents a label with a higher pixel density than the first input image data used in S430. Accordingly, in S450, compared to S430, the likelihood of erroneous detection of an inappropriate label (for example, the second label LB2, a defective label, and so on) is smaller. As a result, the appropriate detection result of the second type region AA2 representing the first label LB1 is used to inspect the first label LB1. This reduces the likelihood of improper inspection.

The first input image data used in S430 represents a label at a lower pixel density than the second input image data used in S450. Thus, the processor 210 appropriately detects the first type region AA1 of the first label LB1 from the first input image IM1, which represents a larger region than the second input image IM2, while suppressing an excessive increase in computational resources (for example, memory capacity used for processing).

As shown in FIGS. 8A to 8E, the first object, which is the object of the processing target, is a label (specifically, the first label LB1). The processor 210 appropriately inspects the label.

In S430 (FIG. 7), the processor 210 detects the first type region AA1 representing the first label LB1 from the first input image IM1 using the first-type object detection model M1. The first-type object detection model M1 is a model trained to detect the first label LB1. The processor 210 appropriately detects the first type region AA1 using the trained first-type object detection model M1. In S450, the processor 210 detects the second type region AA2 representing the first label LB1 from the second input image IM2 using the second-type object detection model M2. The second-type object detection model M2 is a model trained to detect the first label LB1. The processor 210 appropriately detects the second type region AA2 using the trained second-type object detection model M2.

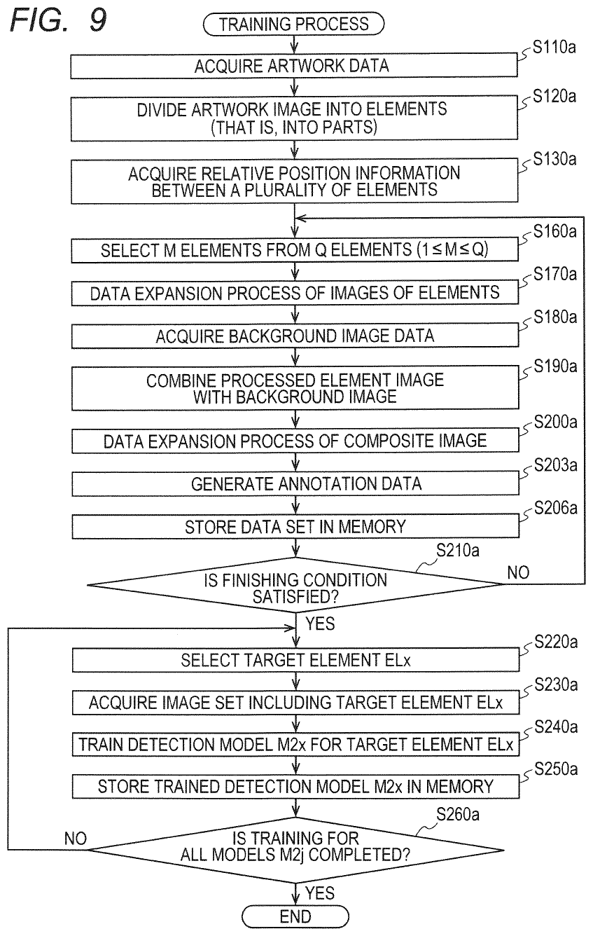

FIG. 9 is a flowchart showing a training process according to a second embodiment. In this embodiment, a second-type object detection model is prepared for each element in the label. Each second-type object detection model detects a corresponding element. The first label LB1 (FIG. 2B) contains seven elements EL1 to EL7. Seven second-type object detection models are prepared to inspect the first label LB1. Hereafter, each second-type object detection model prepared for each element is referred to as “element detection model M2j”. To distinguish between individual element detection models M2j, the letter “j” at the end of each reference sign will be replaced with an identifier for the corresponding element. In this embodiment, each element is assigned an identification number in advance. The number at the end of the reference sign of the element (for example, EL1, EL2, and so on) corresponds to the identification number. For example, a first element detection model M21 is for detecting the first element EL1, and a second element detection model M22 is for detecting the second element EL2. In the training process in FIG. 9, each element detection model M2j is trained. In this embodiment, the second program 232 (FIG. 1) is configured to perform the processing of FIG. 9.

S110a is the same as S110 in FIG. 4. The processor 210 acquires artwork data.

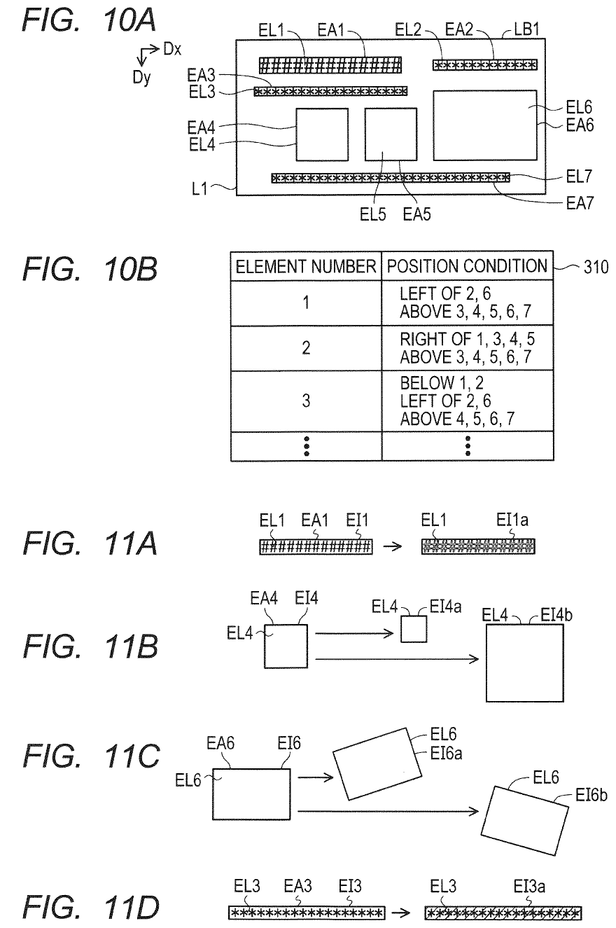

In S120a, the processor 210 analyzes an artwork image and divides the artwork image into a plurality of element regions. An element region is a region that represents an element in the label. FIG. 10A is a schematic diagram of an example of element regions. From the artwork image L1, the processor 210 acquires seven element regions EA1, EA2, EA3, EA4, EA5, EA6, and EA7 representing seven elements EL1, EL2, EL3, EL4, EL5, EL6, and EL7, respectively. Any method may be used to acquire the element regions. For example, the processor 210 selects pixels having colors within a particular background color range as background pixels and selects other pixels as element pixels. The processor 210 selects a region in which a plurality of element pixels are continuous as an element region.

In S130a, the processor 210 acquires relative position information between a plurality of element regions. FIG. 10B is a schematic diagram showing an example of the relative position information. Relative position information 310 shows the correspondence between element numbers and position conditions. The element number indicates the identification number of the element in each element region. The processor 210 determines the element number by analyzing an image of the element region. Any method may be used to determine the element number. For example, the processor 210 determines the element number of each element region by pattern matching using a reference image (not shown) of the element, which is prepared in advance.

The position condition indicates the positional relationship between the element region of the element number and the other element regions. Specifically, the position condition indicates the arrangement of the element region in the first direction Dx and in the second direction Dy relative to the other element regions. The arrangement in the first direction Dx is selected from “right” and “left”. “Right” indicates the first direction Dx, and “left” indicates the opposite direction to the first direction Dx. The arrangement in the second direction Dy is selected from “below” and “above”. “Below” indicates the second direction Dy, and “above” indicates the opposite direction to the second direction Dy. In this embodiment, the center-of-gravity positions of the element regions are compared. As indicated by the position condition of the element number “1”, the element region EA1 is located to the left of the element regions EA2 and EA6 and above the element regions EA3 to EA7. In a case where the difference in position between two element regions is less than or equal to a particular position threshold, the relative positions of the two element regions are omitted from the position condition. For example, in the example in FIG. 10A, the difference in position in the second direction Dy between the first element region EA1 and the second element region EA2 is small. Thus, the arrangement of the first element region EA1 in the second direction Dy with respect to the second element region EA2 is omitted. The relative position information 310 further indicates the respective position conditions of the other element regions EA2 to EA7 (the position conditions of the element regions EA4 to EA7 are not shown in the drawing).

The processor 210 stores data indicating the relative position information 310 in the memory 215 (for example, the nonvolatile memory 230). The relative position information 310 is referenced in the inspection process described later (the relative position information 310 will also be referred to as “reference position information 310”).

S160a to S210a (FIG. 9) is processing of generating training image data. In this embodiment, the processor 210 generates training image data for each of the plurality of element detection models M2j.

In S160a, the processor 210 selects M elements from Q elements. Q is the total number of elements of the processing target. In this embodiment, all the elements EL1 to EL7 of the first label LB1 are to be processed. Thus, the number Q is the same as the total number of elements N of the first label LB1 (in this embodiment, Q=N=7). M is an integer greater than or equal to 1 and less than or equal to Q. In this embodiment, M=1. The processor 210 selects M elements from the Q elements by using a random number. A case where M is set to 2 or more is described in another embodiment later.

In S170a, the processor 210 performs a data expansion process on the element images. The processor 210 acquires M image data of M element regions corresponding to M elements from the artwork data (the acquired data is referred to as “element image data”). The processor 210 performs the data expansion process for each of the M element image data. The processor 210 generates processed element image data by performing various types of image processing, similar to the data expansion process in S170 of FIG. 4. FIGS. 11A to 11D are schematic diagrams showing examples of image processing.

The image processing in FIG. 11A is a color change process. The color change process is the same as the color change process in the embodiment in FIG. 5A. For example, the processor 210 generates the data of a processed element image EI1a by changing the color value of an element image EI1 of the first element region EA1.

The image processing in FIG. 11B is an image resizing process. The image resizing process is the same as the image resizing process in the embodiment in FIG. 5B. For example, the processor 210 generates data of a processed element image EI4a, which represents the element EL4 after being reduced, by performing a reduction process on data of an element image EI4 of the fourth element region EA4. The processor 210 also generates data of a processed element image EI4b, which represents the element EL4 after being enlarged, by performing an enlargement process on data of the element image EI4.

The image processing in FIG. 11C is an image rotation process. The image rotation process is the same as the image rotation process in the embodiment in FIG. 5C. For example, the processor 210 generates data of a processed element image EI6a, which represents the sixth element EL6 after being rotated, by rotating an element image EI6 of the sixth element region EA6 counterclockwise. The processor 210 also generates data of a processed element image EI6b, which represents the sixth element EL6 after being rotated, by rotating the element image EI6 clockwise.

The image processing in FIG. 11D is a blurring process. The blurring process is the same as the blurring process in the embodiment in FIG. 5D. For example, the processor 210 performs the blurring process on an element image EI3 of the third element region EA3 to generate data of a processed element image EI3a representing the third element EL3 after being blurred.

In S170a (FIG. 9), the processor 210 uses random numbers to determine the type of the image processing for each of the M element images in S170a, similar to S170 in FIG. 4.

S180a is the same as S180 in FIG. 4. The processor 210 acquires background image data.

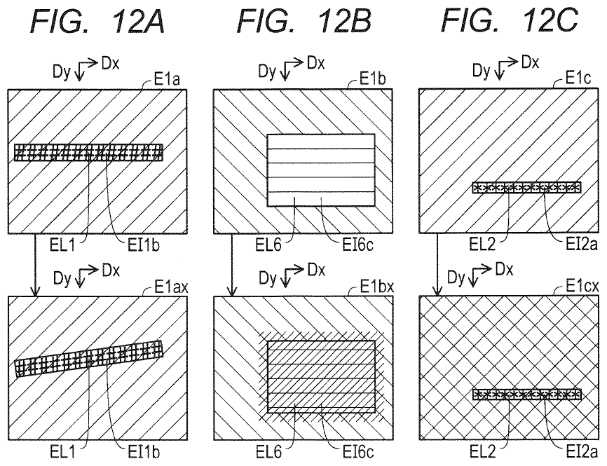

In S190a, the processor 210 generates a composite image by combining the background image and the M processed element images. The processor 210 determines the position of each of the M processed element images on the background image by using a random number. FIGS. 12A to 12C are schematic diagrams of examples of composite images. A composite image E1a in FIG. 12A is acquired by superimposing a processed element image EI1b of the first element EL1 on a background image. A composite image E1b in FIG. 12B is acquired by superimposing a processed element image EI6c of the sixth element EL6 on a background image. A composite image E1c in FIG. 12C is acquired by superimposing a processed element image EI2a of the second element EL2 on a background image.

In S200a, the processor 210 performs a data expansion process of the composite image. In S200a, similar to S170a, the processor 210 performs various image processing. For example, a processed composite image E1ax in FIG. 12A is generated by performing a rotation process on the composite image E1a. A processed composite image E1bx in FIG. 12B is generated by performing a blurring process on the composite image E1b. A processed composite image E1cx in FIG. 12C is generated by performing a noise addition process on the composite image E1c. The processor 210 uses random numbers to determine the type of the image processing of S200a.

In S203a, the processor 210 generates annotation data to be associated with the processed composite image data. The annotation data indicates the appropriate bounding box and the appropriate class (for example, element identification number). In this embodiment, the processor 210 generates the annotation data based on the processing content of S170a, S190a, and S200a.

In S206a, the processor 210 stores a set of the second type training image data, which is the data of the processed composite image, and the annotation data in the nonvolatile memory 230.

In S210a, the processor 210 determines whether a finishing condition is satisfied. In this embodiment, the finishing condition may be any type of condition indicating that a plurality of training image data for appropriately training each of the Q element detection models M2j is generated. For example, the finishing condition may be that an element finishing condition for each of the Q elements is satisfied. The element finishing condition for one target element may be that the total number of training image data containing images of the target element is greater than a particular threshold. In a case where the finishing condition is not satisfied (S210a: No), the processor 210 returns the processing to S160a to generate new training image data.

In a case where the finishing condition is satisfied (S210a: Yes), the processor 210 performs S220a to S260a such that the Q element detection models M2j corresponding to the Q elements are trained, one at a time, sequentially.

In S220a, the processor 210 selects a target element ELx, which is one element to be processed, from the Q elements. An untrained element is selected as the target element ELx.

In S230a, the processor 210 acquires a data set of training images containing images of the target element ELx from the nonvolatile memory 230.

In S240a, the processor 210 trains the target element detection model M2x, which is the element detection model M2j corresponding to the target element ELx, by using the data set of training images acquired in S230a. The training method is the same as that in S240 in FIG. 4. The target element detection model M2x is trained to detect the target element ELx.

In S250a, the processor 210 stores data indicating the trained target element detection model M2x in the memory 215 (here, the nonvolatile memory 230).

In S260a, the processor 210 determines whether the training of the Q element detection models M2j corresponding to the Q elements is completed. In a case where untrained element detection models M2j remain (S260a: No), the processor 210 returns the processing to S220a to train the target element detection model M2x corresponding to a new target element ELx. In a case where the training of the Q element detection models M2j is completed (S260a: Yes), the processor 210 ends the processing of FIG. 9.

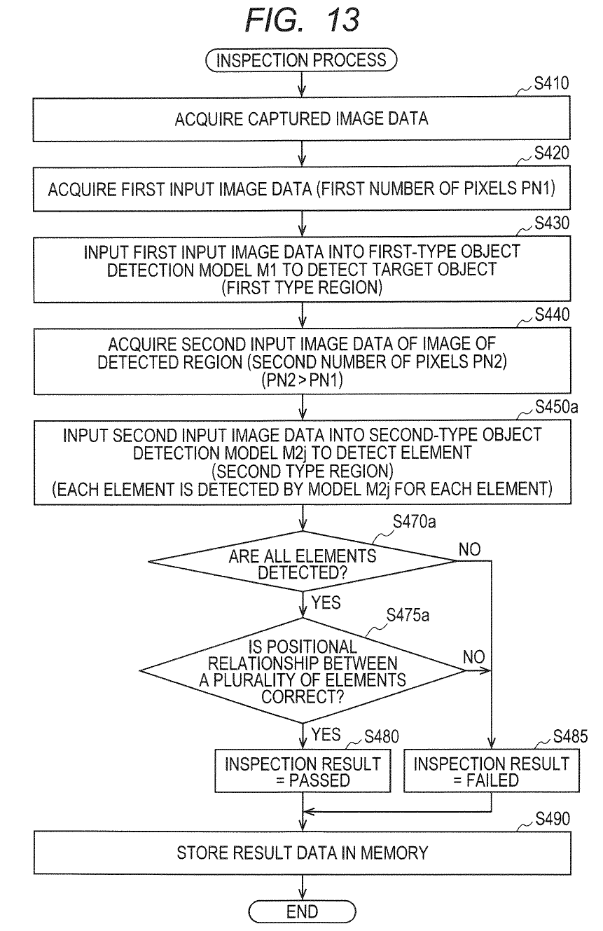

FIG. 13 is a flowchart showing an inspection process according to a second embodiment. The difference from the inspection process in FIG. 7 is that S450 and S460 are replaced by S450a, S470a, and S475a. The processing of the steps S410 to S440 and S480 to S490 is the same as the processing of the steps with the same reference sign in FIG. 7 (description is omitted). In this embodiment, the third program 233 (FIG. 1) is configured to perform the processing of FIG. 13.

After S440, in S450a, the processor 210 inputs the second input image data into each of the N element detection models M2j to detect the N elements. The N element detection models M2j are models that have already been trained by the training process in FIG. 9.

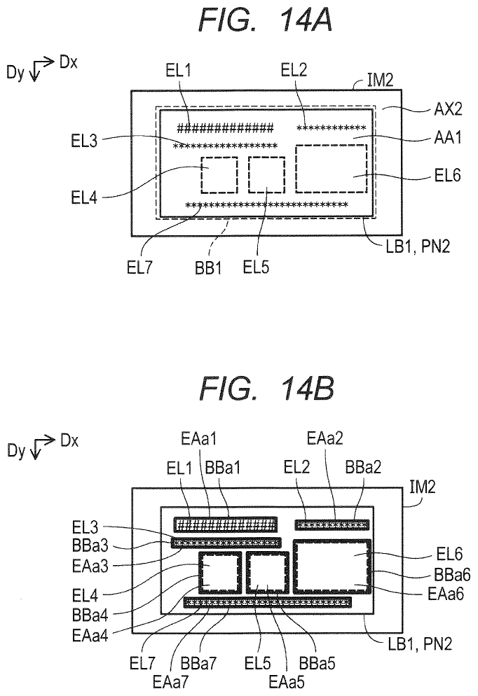

FIGS. 14A and 14B are schematic diagrams of element detection. FIG. 14A shows an example of the second input image IM2. The second input image IM2 is the same as the second input image IM2 in FIG. 8D. FIG. 14B shows an example of bounding boxes detected from the second input image IM2. In this embodiment, the processor 210 uses seven element detection models M2j to detect seven bounding boxes BBa1 to BBa7, which represent the seven elements EL1 to EL7. Element regions EAa1 to EAa7 are regions surrounded by the bounding boxes BBa1 to BBa7, respectively.

In S470a (FIG. 13), the processor 210 determines whether all the N elements (here, N bounding boxes) are detected. If one or more elements are not detected (S470a: No), in S485, the processor 210 sets the inspection result to “Failed”. The processor 210 advances the processing to S490.

If all the N elements are detected (S470a: Yes), in S475a, the processor 210 determines whether the positional relationships between the N elements that are detected is correct. The processor 210 acquires the relative position information between the N element regions EAa1 to EAa7 (FIG. 14B) (referred to as the “target position information”) by using the same method as the method used to acquire the reference position information 310 (FIG. 10B) in S130a (FIG. 9). In this embodiment, the orientation of the first label LB1 in the second input image IM2 is assumed to be approximately the same as the orientation of the first label LB1 in the artwork image L1 (FIG. 10A). Accordingly, the reference position information 310 is used as information indicating the appropriate positional relationships between the N element regions EAa1 to EAa7. The processor 210 compares the target position information with the reference position information 310 to determine whether the positional relationships between the N elements that are detected (that is, the N element regions EAa1 to EAa7) is correct. In a case where all positional relationships indicated by the target position information are included in the position condition of the reference position information 310, the processor 210 determines that the positional relationships are correct. In a case where the target position information indicates a positional relationship that is not included in the position condition of the reference position information 310, the processor 210 determines that the positional relationships are not correct.

In response to determining that the positional relationships are correct (S475a: Yes), the processor 210 sets the inspection result to “Passed” in S480. Then, the processor 210 advances the processing to S490. In response to determining that the positional relationships are incorrect (S475a: No), in S485, the processor 210 sets the inspection result to “Failed”. The processor 210 advances the processing to S490. In S490, the processor 210 stores data indicating the inspection result in the memory 215 (for example, the nonvolatile memory 230). The processor 210 ends the processing of FIG. 13.

As described above, in this embodiment, the processor 210 of the data processing apparatus 200 performs the following processing. The processing in S430 of FIG. 13 is the same as the processing in S430 of FIG. 7. In S450a of FIG. 13, the processor 210 uses the second input image data to detect the element regions EAa1 to EAa7 representing the elements EL1 to EL7, which are part of the first label LB1, from the second input image IM2 (FIG. 14B). The second input image IM2 is the same as the second input image IM2 in FIG. 8D. The element regions EAa1 to EAa7 are examples of second type regions that represent at least part of the first label LB1.

In S470a, S475a, S480, and S485, the processor 210 inspects the first label LB1 using the detection results of the second type regions (here, the element regions EAa1 to EAa7). The second input image data used in S450a represents the label at a higher pixel density than the first input image data used in S430. Thus, the likelihood of erroneous detection of an inappropriate element (for example, an element not included in the first label LB1) in S450a is smaller than a case where it is assumed that the elements are detected from the first input image data. As a result, the appropriate detection result for the second type region (here, the element regions EAa1 to EAa7) representing a portion of the first label LB1 is used to inspect the first label LB1, and the likelihood of inappropriate inspection is reduced.

The first input image data used in S430 represents the label at a lower pixel density than the second input image data used in S450a. Thus, the processor 210 appropriately detects the first type region AA1 of the first label LB1 from the first input image IM1, which represents a larger region than the second input image IM2, while suppressing an excessive increase in computational resources (for example, memory capacity used for processing).

As shown in FIG. 14A, the first label LB1 contains the N (N is an integer greater than or equal to 2, in this embodiment N=7) elements EL1 to EL7. In S450a (FIG. 13), the processor 210 detects, from the second input image IM2, the N element regions EAa1 to EAa7 representing the N elements EL1 to EL7, respectively. In S470a to S485, the processor 210 inspects the first label LB1 using the element regions EAa1 to EAa7. In S475a, the processor 210 inspects the first label LB1 by comparing the positional relationship between the N element regions EAa1 to EAa7 and the reference position information 310. The reference position information 310 indicates the particular positional relationship between the N elements EL1 to EL7. With this configuration, the processor 210 uses the positional relationship of the N elements EL1 to EL7 in the label to perform an appropriate inspection. For example, in a case where the label has a defect, such as element misalignment, the processor 210 appropriately determines that the inspection result is “Failed”.

In S450a, the processor 210 detects the N element regions EAa1 to EAa7 respectively representing the N elements EL1 to EL7 detected from the second input image IM2, by using the N element detection models M2j that have been trained to detect the N elements EL1 to EL7. Accordingly, the processor 210 uses the appropriate N element regions EAa1 to EAa7 for label inspection.

In S430 (FIG. 13), the processor 210 detects the first type region AA1 representing the first label LB1 from the first input image IM1 by using the first-type object detection model M1. The first-type object detection model M1 is a model that has been trained to detect the first label LB1. The processor 210 uses the trained first-type object detection model M1 to appropriately detect the first type region AA1. In S450a, the processor 210 uses the second-type object detection model M2j to detect the corresponding element region from the second input image IM2 (specifically, the corresponding region among the element regions EAa1 to EAa7). The element region is an example of a second type region representing a part of the first label LB1. The second-type object detection model M2j is a model that has been trained to detect the corresponding element region. The processor 210 uses the trained second-type object detection model M2j to appropriately detect the second type region.

In this embodiment, if one or more of the N elements EL1 to EL7 of the first label LB1 are not detected (S470a: No), the inspection result is “Failed”. Thus, in a case where the label of the MFP 900 has a defect (for example, missing elements), the processor 210 appropriately determines that the inspection result is “Failed”. In a case where the target position information indicates a positional relationship that is not included in the position condition of the reference position information 310 (S475a: No), the inspection result is “Failed”. Thus, in a case where the label of the MFP 900 has a defect (for example, misalignment of elements, and so on), the processor 210 appropriately determines that the inspection result is “Failed”.

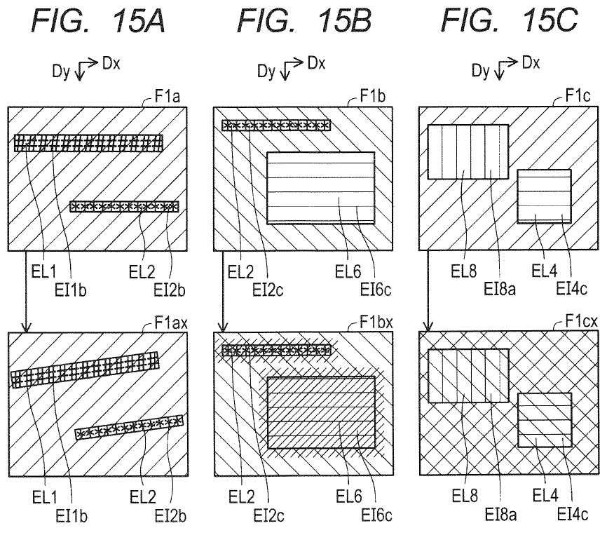

FIGS. 15A to 15C are schematic diagrams showing examples of composite images used in a training process according to a third embodiment. There are two differences from the training process in the second embodiment. The first difference is that in S160a of FIG. 9, the processor 210 uses a random number to determine the number M between 1 and Q, and in this embodiment, the number M may be two or more. In S170a, the processor 210 uses a random number to determine the image processing for each element. The second difference is that, in S190a, the processor 210 combines the M (M may be two or more) processed element images of the M elements with a background image. The processing of the other parts of the training process is the same as that of the corresponding parts of FIG. 9 (explanation of the same parts is omitted). The second program 232 (FIG. 1) is configured to perform the training process of this embodiment. In the inspection process of FIG. 13, the N element detection models M2j may be used, which are trained by the training process of this embodiment.

A composite image F1a in FIG. 15A is acquired by superimposing the processed element image EI1b of the first element EL1 and a processed element image EI2b of the second element EL2 on a background image (S190a). A processed composite image F1ax is generated by performing a rotation process on the composite image F1a (S200a).

A composite image F1b in FIG. 15B is acquired by superimposing a processed element image EI2c of the second element EL2 and the processed element image EI6c of the sixth element EL6 on a background image (S190a). A processed composite image F1bx is generated by performing a blurring process on the composite image F1b (S200a).

A composite image F1c in FIG. 15C is acquired by superimposing a processed element image EI4c of the fourth element EL4 and a processed element image EI8a of the eighth element EL8 on a background image (S190a). A processed composite image F1cx is generated by performing a noise addition process on the composite image F1c (S200a). In this way, in addition to the M elements, the processor 210 may combine the image of an external element (for example, the eighth element EL8), which is an element not included in the first label LB1 of the processing target, with the background image. For example, in S170a, the processor 210 performs a data expansion process on the image of the external element. In S190a, the processor 210 combines the processed element image of the external element with the background image. The processor 210 may use a random number to determine whether to combine the image of the external element.

The total number of element images in one composite image may be any number greater than one (not shown). In a case where one composite image contains a plurality of element images, the processor 210 combines the plurality of element images such that the plurality of element images do not overlap each other.

In this embodiment, the element detection model M2j is trained to detect a corresponding element. The element detection model M2j is trained not to detect other elements that are different from the corresponding element. For example, in a case where the composite image generated in S190a of FIG. 9 contains a plurality of element images, the annotation data generated in S203a shows the bounding box and the class of each of the plurality of elements. In S240a, the processor 210 omits the data of bounding boxes and classes of the elements other than the target element ELx from the annotation data. The element detection model M2j may be trained to detect other elements in addition to the corresponding element.

As described above, in this embodiment, each of the Q object detection models is trained by using image data of an image representing a plurality of elements, including the corresponding element and other elements. For example, the first element detection model M21 for the first element EL1 is trained by using image data of the processed composite image F1ax (FIG. 15A) representing a plurality of elements including the first element EL1 and the second element EL2. By using the processed composite image F1ax, the first element detection model M21 is trained to detect the first element EL1 without erroneously detecting the second element EL2 as the first element EL1. As a result, the likelihood of erroneous detection by the first element detection model M21 is reduced. The element detection models M2j corresponding to the other elements EL2 to EL7 are similarly trained by using image data of images representing a plurality of elements including the corresponding element and other elements. This reduces the likelihood of erroneous detection.

As shown in FIG. 10A, the N (here, N=7) elements of the first label LB1 include the first element EL1 and the second element EL2. As explained with reference to FIG. 9, the N element detection models M2j include the first element detection model M21 for detecting the first element EL1 and the second element detection model M22 for detecting the second element EL2. The processed composite image F1ax in FIG. 15A contains the image of the first element EL1 and the image of the second element EL2. The processed composite image F1ax is used for training the first element detection model M21 and the second element detection model M22. That is, the first element detection model M21 is trained by using a first image data set that includes image data (referred to as “first image data”) of the image F1ax representing a plurality of elements including the first element EL1 and the second element EL2. The second element detection model M22 is trained by using a second image data set containing the first image data. In this way, the first image data of the processed composite image F1ax is used to train a plurality of element detection models M2j, thus reducing the total number of image data for training each of the N element detection models M2j. The first image data set is a data set of a plurality of training images including images of the first element EL1. The second image data set is a data set of a plurality of training images including images of the second element EL2.

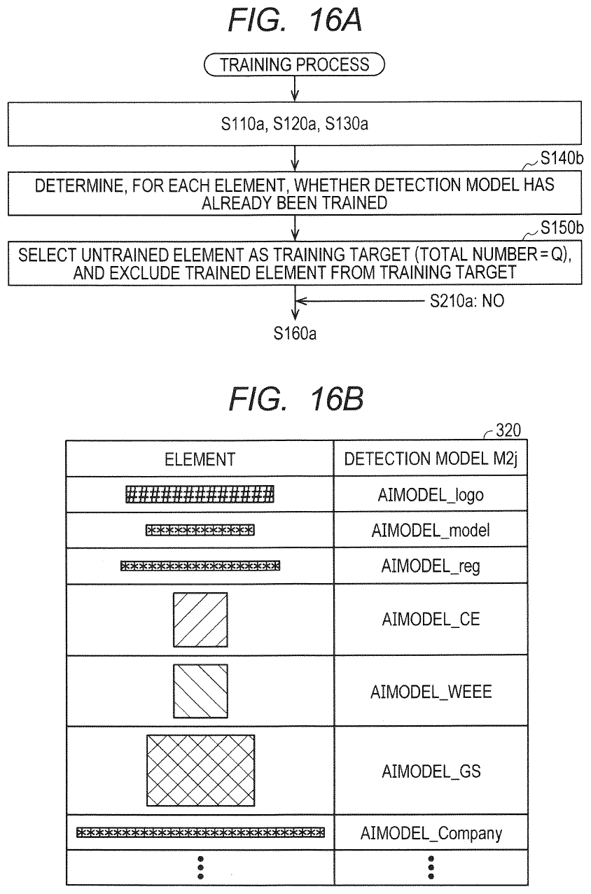

FIG. 16A is part of a flowchart of a training process according to a fourth embodiment. The difference from the training process in FIG. 9 is that S140b and S150b are inserted between S130a and S160a. In this embodiment, the trained element detection models M2j for other labels are reused. The number Q referenced in S160a (FIG. 9) indicates the total number of untrained element detection models M2j. In S250a, the processor 210 stores, in the memory 215 (here, the nonvolatile memory 230), the data of the trained element detection model M2j in association with image data of the corresponding element. The data that is stored is referred to as “model data”. Processing of other parts of the training process is the same as the processing of the corresponding parts of FIG. 9 (description of the same parts is omitted).

The second program 232 (FIG. 1) is configured to perform the training process in this embodiment.

In S140b (FIG. 16A), the processor 210 determines whether the corresponding element detection model M2j has already been trained, for each of the plurality of elements EL1 to EL7 of the first label LB1 of the processing target. To make this determination, the processor 210 refers to the model data that is stored in the nonvolatile memory 230 in S250a (FIG. 9) in the training process of other labels. FIG. 16B is a schematic diagram of the model data. Model data 320 includes data of the trained element detection model M2j and image data of the corresponding element, in association with each other.

It is assumed that the training process for the second label LB2 (FIG. 2C) is performed before the training process for the first label LB1. In this case, at the time when S140b (FIG. 16A) for the first label LB1 is performed, the model data 320 includes data related to the seven element detection models M2j for the seven elements EL1, EL3 to EL5, and EL7 to EL9 of the second label LB2. The processor 210 refers to the model data 320 to determine whether the element detection model M2j has been trained for each of the plurality of elements EL1 to EL7 of the first label LB1. In this embodiment, the processor 210 performs pattern matching between the image of the element region (that is, the image of the element of the first label LB1) acquired in S120a (FIG. 9) and the image of the element indicated by the model data 320. In response to detecting an image that matches the image of the element in the first label LB1 from the model data 320, the processor 210 determines that the element detection model M2j for that element has been trained. It is determined that the element detection models M2j for the elements EL1, EL3 to EL5, and EL7 included in the second label LB2 have been already trained. It is determined that the element detection models M2j for the elements EL2 and EL6, which are not included in the second label LB2, have not been trained yet (untrained).

In S150b (FIG. 16A), the processor 210 selects an untrained element (here, an element corresponding to an untrained element detection model M2j) as a training target. The processor 210 does not select a trained element (here, an element corresponding to a trained element detection model M2j) as a training target. In other words, the processor 210 excludes the trained elements from the training target. Hereinafter, the total number of untrained elements is assumed to be Q. In subsequent processing (S160a to S260a in FIG. 9), the processor 210 trains the element detection model M2j for each of the Q untrained elements. In a case where the training of the Q element detection models M2j is completed (S260a: Yes), the processor 210 ends the training process (FIG. 9, FIG. 16A). The seven trained element detection models M2j corresponding to the seven elements EL1 to EL7 of the first label LB1 are used in the inspection process (FIG. 13) of the first label LB1.

As described above, in this embodiment, the N (here, N=7) elements EL1 to EL7 of the first label LB1 (FIG. 2B) include the first element EL1 and the second element EL2. The N element detection models M2j used in the inspection of the first label LB1 include the first element detection model M21 for detecting the first element EL1 and the second element detection model M22 for detecting the second element EL2. The first element detection model M21 used in the inspection of the first label LB1 is a pre-trained object detection model for the second label LB2, which is different from the first label LB1 and includes the first element EL1. The second element detection model M22 used in the inspection of the first label LB1 is an object detection model that is trained for the first label LB1. Thus, the first element detection model M21, which has been trained for the first element EL1 of the second label LB2, is reused for the first element EL1 of the first label LB1. This reduces a burden for the inspection of the first label LB1 (for example, the burden of training the element detection model M2j).

The N element detection models M2j used in the inspection process for the first label LB1 are prepared by the training process that includes the following processing. In S140b (FIG. 16A), the processor 210 determines whether the element detection model M2j is trained. In S150b to S260a (FIG. 16A, FIG. 9), in a case where the element detection model M2j is not trained, the processor 210 trains the element detection model M2j. In S150b, in a case where the element detection model M2j is trained, the processor 210 excludes the element detection model M2j from training. Thus, the element detection model M2j that has already been trained is excluded from the training. This reduces a burden for the inspection of the first label LB1 (for example, the burden of training the element detection model M2j).

In this embodiment, the N (here, N=7) elements EL1 to EL7 of the first label LB1 include the sixth element EL6 in addition to the first element EL1 and the second element EL2. The N element detection models M2j used to inspect the first label LB1 include an element detection model M26 for detecting the sixth element EL6. The sixth element EL6 is not included in the second label LB2 (FIG. 2C). Thus, the element detection model M26 for the sixth element EL6 is trained in the training process for the first label LB1. The element detection model M22 for the second element EL2 and the element detection model M26 for the sixth element EL6 are trained by using image data of images representing a plurality of elements, including the second element EL2 and the sixth element EL6. For example, in S230a(FIG. 9), an image data set containing image data of the processed composite image F1bx (FIG. 15B) representing a plurality of elements including the second element EL2 and the sixth element EL6 is selected for the second element detection model M22 corresponding to the second element EL2. And, an image data set containing image data of the processed composite image F1bx is selected for the element detection model M26 corresponding to the sixth element EL6. Thus, the same processed composite image F1bx data is used for training the element detection model M22 corresponding to the second element EL2 and the element detection model M26 corresponding to the sixth element EL6. This reduces the total number of image data for training the N element detection models M2j. The data set for the second element EL2 is a data set of a plurality of training images including images of the second element EL2. The data set for the sixth element EL6 is a data set of a plurality of training images containing images of the sixth element EL6.

While the disclosure has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the disclosure, and not limiting the disclosure. Various changes may be made without departing from the spirit and scope of the disclosure. Thus, the disclosure is intended to embrace all known or later developed alternatives, modifications, variations, improvements, and/or substantial equivalents. Some specific examples of potential alternatives, modifications, or variations in the described disclosure are provided below.

(1) The element detection model M2j (FIG. 9 and so on) may be trained by using training images that include an image of the corresponding element and do not include images of other elements. In the embodiment of FIGS. 15A to 15C, a common training image is used for training of a plurality of element detection models M2j. For example, the processed composite image Flax is used for training of the first element detection model M21 and training of the second element detection model M22. Alternatively, the plurality of element detection models M2j may be trained by using different sets of training image data.

(2) In the above embodiment, the training image data is generated by the data expansion process. The data set of the training image may include captured image data of a real object of a detection target (for example, the first label LB1, the elements EL1 to EL7, and so on) without a defect. The training image data may include image data generated by the data expansion process on the captured image data. The training image data may be generated by using the captured image data instead of the artwork data. The generation of the training image data by the data expansion process may be omitted. For example, one or more captured image data may be used as the training image data. The illumination (specifically, the type and brightness of the light source) and the position (specifically, the position of the digital camera with respect to the detection target) at the time of capturing for the training image may be various illuminations and positions suitable for preparation of the training image. The illumination and position may be adjusted by the operator. The method of generating the annotation data associated with the training image data may be various methods, instead of the method described in S203 (FIGS. 4) and S203a (FIG. 9). For example, the processor 210 may generate annotation data by pattern matching using a reference image of the detection target. The processor 210 may generate annotation data using information input by the operator. For example, the processor 210 displays the processed composite image on the display 240. The operator inputs information indicating the bounding box and the class suitable for the processed composite image to the data processing apparatus 200 via the operation interface 250. The processor 210 generates annotation data by using the information that is input.

(3) The first-type object detection model M1 may be various other object detection models (for example, SSD (Single Shot MultiBox Detector), R-CNN (Region Based Convolutional Neural Networks, and so on), instead of YOLOv4. Detection models using CNNs such as YOLO, SSD, R-CNN, and so on are suitable for detecting an image of an object. However, the first-type object detection model M1 may be an object detection model that does not include CNNs (for example, a model configured by a fully-connected layer). The processor 210 may detect the target object by pattern matching using a reference image of the target object (for example, the first label LB1), without using the first-type object detection model M1.

Similarly, the second-type object detection models M2 and M2j may be various other object detection models instead of YOLOv4. Detection models using CNNs is suitable for detecting an image of an object. However, the second-type object detection models M2 and M2j may be object detection models (for example, models configured by a fully connected layer) that do not include CNNs. The second-type object detection models M2 and M2j may be the same models as the first-type object detection model M1. The second-type object detection models M2 and M2j may be models different from the first-type object detection model M1. The processor 210 may detect the target object by pattern matching using a reference image of the target object (for example, the first label LB1, the elements EL1 to EL7, and so on), without using the second-type object detection models M2 and M2j.

(4) The training process of the object detection models may be various other processes instead of the training process described above. For example, the determination method of S140b (FIG. 16A) may be various methods. For example, in the model data 320 (FIG. 16B), an identifier (for example, an identification number) of an element may be associated with a detection model. The processor 210 may analyze the image of the element acquired in S120a (FIG. 9) to determine the identification number of the element, and search the model data 320 for information associated with the determined identification number. The method of determining the identification number of the element may be various methods. For example, the processor 210 may determine the identification number of the image of the element by pattern matching using a reference image (not shown) of the element prepared in advance. The operator may input information indicating whether the element detection model M2j has been trained to the data processing apparatus 200. For example, the processor 210 displays an image of the element acquired in S120a (FIG. 9) on the display 240. The operator observes the displayed image and inputs information indicating whether the corresponding element detection model M2j has been trained to the data processing apparatus 200 via the operation interface 250. The processor 210 determines whether the element detection model M2j has been trained, by using the input information.

The process of acquiring the element region from the artwork image in S120a of FIG. 9 may be various other processes instead of the process using the background pixels and the element pixels. For example, the processor 210 may determine the element region by pattern matching using a reference image (not shown) of the element prepared in advance.

The training process of the object detection models may be performed by another apparatus (for example, another data processing apparatus) different from the data processing apparatus 200 that performs the inspection process.

(5) The inspection process of the target object may be various other processes instead of the above-described process. For example, the orientation of the first label LB1 in the second input image IM2 (FIG. 14A) may be different from the orientation of the first label LB1 in the artwork image L1 (FIG. 10A). In this case, in S475a (FIG. 13), the processor 210 may acquire the target position information after matching the orientation of the first label LB1 with the orientation of the first label LB1 in the artwork image L1 by the rotation process of the second input image IM2. The method of determining the rotation angle for the rotation process may be various methods. For example, the processor 210 may determine the angle by pattern matching between the second input image IM2 and the artwork image L1.

The processor 210 may generate data of a difference image between an image of the first label LB1 detected from the second input image IM2 and a reference image of the first label LB1, as data indicating the inspection result. The reference image may be a predetermined image. Alternatively, the reference image may be an image generated by an image generation model (for example, an autoencoder) trained to generate an image of the first label LB1 without a defect from an image of the first label LB1 with a defect.

(6) The target object may be a label provided on various products other than the MFP 900. The product may be any product such as a printer, a sewing machine, a machine tool, a cutting machine, a scanner, a smartphone, and so on. The product may be a component of another product. For example, the target object may be a label provided on a discharge tray which is a component attached to an MFP.

(7) The target object may be any other object instead of a label. For example, the target object may be a three-dimensional inscription (a manufacturer's logo, a product brand, and so on) or a painted pattern.

(8) The data processing apparatus 200 of FIG. 1 may be an apparatus of a type different from a personal computer (for example, a digital camera, a scanner, or a smartphone). Further, a plurality of apparatuses (for example, computers) configured to communicate with each other via a network may share some of the data processing functions of the data processing apparatus and provide the data processing functions as a whole. In this case, a system including these apparatuses corresponds to the data processing apparatus.

In each of the above-described embodiments, a part of the configuration realized by hardware may be replaced by software, and conversely, a part or all of the configuration realized by software may be replaced by hardware. For example, the function of the first-type object detection model M1 may be realized by a dedicated hardware circuit. Further, a plurality of processors such as CPUs and GPUs may be provided, and the plurality of processors may individually or collectively perform the described steps. In this case, one of the plurality of processors may perform each of the described steps, or two or more of the plurality of processors may perform the described steps in a distributed manner.

In a case where a part or all of the functions of the present disclosure are realized by a computer program, the program may be provided in a form stored in a computer-readable storage medium (for example, a non-transitory storage medium). The program may be used in a state of being stored in the same storage medium as that at the time of provision of the program, or may be used in a state of being stored in a different storage medium (computer-readable storage medium). The “computer-readable storage medium” is not limited to a portable storage medium such as a memory card or a CD-ROM, and may include an internal memory in a computer such as various ROMs or an external memory connected to a computer such as a hard disk drive.

What is claimed is:

1. A non-transitory computer-readable storage medium storing a set of program instructions for a computer, the set of program instructions, when executed by the computer, causing the computer to perform:
acquiring captured image data of a captured image including a first object;
acquiring first image data from the captured image data, the first image data representing the first object with a first number of pixels;
detecting a first type region indicating the first object by using the first image data;
acquiring second image data from the captured image data, the second image data indicating a partial image, the partial image including the first type region of the captured image, the partial image not including at least part of a remaining region other than the first type region of the captured image;
detecting a second type region by using the second image data, the second type region indicating at least part of the first object, the second image data representing the first object with a second number of pixels, the second number of pixels being greater than the first number of pixels; and
inspecting the first object by using a detection result of the second type region.

2. The non-transitory computer-readable storage medium according to claim 1, wherein the first object is a label.

3. The non-transitory computer-readable storage medium according to claim 1, wherein the first object includes N (N is an integer greater than or equal to 2) elements;
wherein the detecting the second type region includes detecting, from the partial image, N second type regions indicating respective ones of the N elements; and
wherein the inspecting includes inspecting the first object by comparing a positional relationship of the N second type regions with a particular positional relationship of the N elements.

4. The non-transitory computer-readable storage medium according to claim 3, wherein the detecting the N second type regions includes detecting, from the partial image, the N second type regions indicating respective ones of the N elements by using N element detection models, the N element detection models being trained to detect respective ones of the N elements.

5. The non-transitory computer-readable storage medium according to claim 4, wherein each of the N element detection models is trained by using image data indicating a plurality of elements, the plurality of elements including a corresponding element and an other element, the corresponding element being an element corresponding to one of the N element detection models for which training is performed, the other element being an element other than the corresponding element.

6. The non-transitory computer-readable storage medium according to claim 4, wherein the N elements include a first element and a second element;
wherein the N element detection models include a first element detection model for detecting the first element and a second element detection model for detecting the second element;
wherein the first element detection model is trained by using a first image data set, the first image data set including first image data indicating a plurality of elements including the first element and the second element; and
wherein the second element detection model is trained by using a second image data set, the second image data set including the first image data.

7. The non-transitory computer-readable storage medium according to claim 4, wherein the N elements include a first element and a second element;
wherein the N element detection models include a first element detection model for detecting the first element and a second element detection model for detecting the second element;
wherein the first element detection model is trained for a second object including the first element, the second object being different from the first object;
wherein the second element detection model is trained for the first object; and
wherein the first element detection model is not trained again for the first object.

8. The non-transitory computer-readable storage medium according to claim 7, wherein each of the N element detection models is prepared by:
determining whether an element detection model is already trained, the element detection model being sequentially selected from the N element detection models;
in response to determining that the element detection model is not trained yet, training the element detection model; and
in response to determining that the element detection model is already trained, excluding the element detection model from a training target.

9. The non-transitory computer-readable storage medium according to claim 7, wherein the N elements further include a third element;
wherein the N element detection models further include a third element detection model for detecting the third element;
wherein the third element detection model is trained for the first object;
wherein the second element detection model is trained by using a first image data set, the first image data set including particular image data indicating the second element and the third element; and
wherein the third element detection model is trained by using a second image data set, the second image data set including the particular image data.

10. The non-transitory computer-readable storage medium according to claim 1, wherein the detecting the first type region includes detecting the first type region indicating the first object from the captured image, by using a first-type object detection model that is trained to detect the first object; and
wherein the detecting the second type region includes detecting the second type region indicating at least part of the first object from the partial image, by using a second-type object detection model that is trained to detect the at least part of the first object.

11. The non-transitory computer-readable storage medium according to claim 1, wherein the captured image data has a higher pixel density than the first image data and the second image data;
wherein the acquiring the first image data includes performing first resolution conversion of reducing a pixel density of the captured image data to acquire the first image data; and
wherein the acquiring the second image data includes performing second resolution conversion of reducing the pixel density of the captured image data to acquire the second image data.

12. The non-transitory computer-readable storage medium according to claim 1, wherein the acquiring the second image data includes generating the second image data such that an entirety of the first type region and a peripheral portion surrounding the first type region are included in the partial image.

13. The non-transitory computer-readable storage medium according to claim 4, wherein the set of program instructions, when executed by the computer, causes the computer to perform:
determining whether all of the N second type regions have been detected by using the N element detection models;
determining whether positional relationships between the N second type regions are correct;
in response to determining that all of the N second type regions have been detected and determining that the positional relationships between the N second type regions are correct, determining that an inspection result is “passed”; and
in response to determining that at least one of the N second type regions has not been detected or determining that the positional relationships between the N second type regions are not correct, determining that an inspection result is “failed”.

14. The non-transitory computer-readable storage medium according to claim 13, wherein the positional relationships between the N second type regions include information indicating that one of the N second type regions is located above, below, left or right of another one of the N second type regions.

15. A data processing apparatus comprising:
a controller; and
a memory storing a set of program instructions, the set of program instructions, when executed by the controller, causing the data processing apparatus to perform:
acquiring captured image data of a captured image including a first object;
acquiring first image data from the captured image data, the first image data representing the first object with a first number of pixels;
detecting a first type region indicating the first object by using the first image data;
acquiring second image data from the captured image data, the second image data indicating a partial image, the partial image including the first type region of the captured image, the partial image not including at least part of a remaining region other than the first type region of the captured image;
detecting a second type region by using the second image data, the second type region indicating at least part of the first object, the second image data representing the first object with a second number of pixels, the second number of pixels being greater than the first number of pixels; and
inspecting the first object by using a detection result of the second type region.
